(19) United States
(12) Patent Application Publication
(10) Pub. No.: US 2023/0306304 A1
(43) Pub. Date: Sep. 28, 2023

(54) METHOD AND SYSTEM FOR SELECTING MACHINE LEARNING MODEL BASED ON DATA DISTRIBUTION

(71) Applicant: REBELLIONS INC., Seongnam-si (KR)

(72) Inventors: Byungjae LEE, Seongnam-si (KR); Gangmuk LIM, Seongnam-si (KR); Hyo-Eun KIM, Seongnam-si (KR)

(21) Appl. No.: 18/052,528

(22) Filed: Nov. 3, 2022

(30) Foreign Application Priority Data
Feb. 8, 2022 (KR) 10-2022-0016535

(51) Int. Cl. G06N 20/00

(52) U.S. Cl. CPC G06N 20/00

(57) ABSTRACT

A method for selecting a machine learning model based on a data distribution is provided, which is performed by one or more processors and includes acquiring training data including a training time series data item and a plurality of training labels corresponding to the training time series data item, pre-processing a plurality of detailed training data items corresponding to each of a plurality of training label distributions from the training data, training a plurality of machine learning models using pre-processed plurality of detailed training data items and a plurality of detailed training labels corresponding to the plurality of detailed training data items, acquiring time series data and a plurality of labels corresponding to the time series data, and selecting at least one machine learning model of the plurality of machine learning models based on a degree of similarity between the training data and each of the time series data.

### CROSS-REFERENCE TO RELATED APPLICATION

This application claims priority under 35 U.S.C. §119 to Korean Patent Application No. 10-2022-0016535, filed in the Korean Intellectual Property Office on Feb. 8, 2022, the entire contents of which are hereby incorporated by reference.

### TECHNICAL FIELD

The present disclosure relates to a method and an apparatus for selecting a machine learning model based on a data distribution.

### BACKGROUND

The related machine learning technique performs training and testing based on the assumption that the distribution of training data and the distribution of test data are the same or similar to each other. That is, according to the related machine learning technique, a machine learning model is built using a training set in an environment similar to the test environment as much as possible, in order to reduce the degradation of the performance of the machine learning model.

However, in the actual environments where the machine learning model is applied, it is likely that this assumption is not true. In particular, in the case of time series data such as financial data and the like in which label information varies widely according to time, the above assumption that the distribution of the training data and the distribution of the test data are the same or similar to each other may not be established. Accordingly, it may be difficult for the existing machine learning model to adequately respond to time series financial data with high volatility.

### SUMMARY

In order to solve one or more problems (e.g., the problems described above and/or other problems not explicitly described herein), the present disclosure provides a method and a system for selecting a machine learning model based on a data distribution.

The present disclosure may be implemented in a variety of ways, including a method, an apparatus (system), or a non-transitory computer-readable recording medium storing instructions.

The method may include acquiring training data including a training time series data item and a plurality of training labels corresponding to the training time series data item, pre-processing a plurality of detailed training data items corresponding to each of a plurality of training label distributions from the training data, training a plurality of machine learning models using pre-processed plurality of detailed training data items and a plurality of detailed training labels corresponding to the plurality of detailed training data items, acquiring time series data and a plurality of labels corresponding to the time series data, and selecting at least one machine learning model from among the plurality of machine learning models based on a degree of similarity between the training data and each of the time series data.

Each of the training time series data item and the time series data may include data including price information according to time for a stock item on a stock exchange.

Each of the training time series data item and the time series data may include data in tensor form including 2-dimensional (2D) data having, on an X-axis, values obtained by dividing a time by a unit time and having, on a Y-axis, values obtained by dividing the time by a unit price, in which the 2D data may include data according to time of a quantity of each of a plurality of ask prices of a stock item on a stock exchange as values for each of a plurality of coordinates defined according to the time on the X-axis and the price on the Y-axis, and 2D data having data according to time of a quantity of each of a plurality of bid prices of a stock item on the stock exchange as values for each of a plurality of coordinates defined according to the X-axis and the Y-axis.

The pre-processing may include determining each of the plurality of training label distributions by oversampling at least a portion of the plurality of detailed training data items from the training data.

The determining each of the plurality of training label distributions may include when oversampling the at least the portion of the plurality of detailed training data items, augmenting at least a portion of the plurality of detailed training data items.

A distribution of the acquired plurality of labels may include a distribution for labels from a current time point to a past time point that is a predetermined period of time earlier, and the selecting the at least one machine learning model may include calculating a distance between the distribution for labels from the current time point to the past time point that is the predetermined period of time earlier and each of the plurality of training label distributions, and selecting, from among the plurality of training label distributions, a machine learning model that has a training label distribution with a closest calculated distance to the distribution for labels from the current time point to the past time point that is the predetermined period of time earlier.

The predetermined period of time may be adjusted to improve accuracy for inferences from the plurality of machine learning models.

The acquiring the time series data and the plurality of labels corresponding to the time series data may include, as a current time point changes, repeatedly generating a plurality of labels from the changed current time point to a past time point that is a predetermined period of time earlier, and the selecting the at least one machine learning model may include selecting one or more machine learning models from among the plurality of training machine learning models based on a degree of similarity between the time series data including a plurality of repeatedly generated label distributions and each of training data including the plurality of training label distributions.

Each of the training data and the time series data may include data in tensor form including a plurality of 2D data according to time for at least one stock item on each of a plurality of stock exchanges.

The method may further include outputting an inference value at an inference time point based on the time series data by using the selected at least one machine learning model.

There is provided a non-transitory computer-readable recording medium storing instructions for executing the method on a computer.

A system for selecting a machine learning model based on a data distribution is provided, which may include a memory storing one or more instructions, and one or more processors configured to execute the one or more instructions in the memory to acquire training data including a training time series data item and a plurality of training labels corresponding to the training time series data item, pre-process a plurality of detailed training data items corresponding to each of a plurality of training label distributions from the training data, train a plurality of machine learning models using the pre-processed plurality of detailed training data items and a plurality of detailed training labels corresponding to the plurality of detailed training data items, acquire time series data and a plurality of labels corresponding to the time series data, and select at least one machine learning model from among the plurality of machine learning models based on a degree of similarity between the training data and each of the time series data.

A technique for sampling a training label may be used to train a machine learning model for time series data having a wide range of variations according to time. Accordingly, various types of data distributions can be generated and each machine learning model can be trained.

A training model can be selected from among the training models, that has a label distribution most similar to the label distribution of the time series data, and a prediction result for the time series data can be inferred. Accordingly, inference performance for the time series data can be greatly improved in the actual environment where the label distribution of time series data varies widely.

According to some examples of the present disclosure, the label distribution of the training data varies depending on the training labels included in the given training data, and by oversampling a specific label in small number during the data sampling process for training the machine learning model, the label distribution of the training data can be changed. Using the training data having various label distributions generated through such oversampling, a plurality of machine learning models can be trained.

By utilizing the characteristics of the time series data, the distribution of labels from the current time point to a specific time point in the past can be calculated, and the distance between the calculated distribution of labels and the data distributions of existing training models can be calculated. By selecting a model with the closest distance and performing model inference, a training model suitable for the current time point can be selected even in a situation where the label distribution of time series data continuously changes, and more accurate inference is enabled through the selected model.

According to some examples of the present disclosure, by training the machine learning model based on stock item data from a plurality of stock exchanges rather than a single stock exchange, an inference value from the machine learning model trained using various stock exchange information for a specific stock item can be output.

According to some examples of the present disclosure, by adjusting a time range of the time series data included in the time series data during testing or inference in the selected machine learning model, inference from the machine learning model can be further improved.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure would be described with reference to the accompanying drawings described below, where similar reference numerals indicate similar elements, but not limited thereto, in which:

FIG. 1 is a schematic diagram illustrating an example of outputting a prediction result using a machine learning model selected based on a data distribution;

FIG. 2 is a block diagram of an information processing system for selecting a machine learning model based on a data distribution;

FIG. 3 is a diagram illustrating an internal configuration of a processor;

FIG. 4 is a diagram illustrating an example of selecting a machine learning model based on a data distribution and generating an inference result using the selected machine learning model;

FIG. 5 is a diagram illustrating examples of training time series data and time series data;

FIG. 6 is a diagram illustrating an example of selecting a machine learning model using a label distribution for at least one stock item in a plurality of stock exchanges and generating an inference result using the selected machine learning model;

FIG. 7 is a diagram illustrating examples of training time series data and time series data for at least one stock item in a plurality of stock exchanges;

FIG. 8 is a diagram illustrating an example of time series data in which a distribution of labels continuously changes according to time;

FIG. 9 is a flowchart illustrating an example of a method for selecting a machine learning model based on a data distribution;

FIG. 10 illustrates an example of a machine learning model;

FIG. 11 is a configuration diagram of a computing device that trains a machine learning model and outputs an inference value using the machine learning model selected based on a distribution of labels; and

FIG. 12 is a diagram illustrating an internal configuration of a plurality of processors.

### DETAILED DESCRIPTION

Hereinafter, examples for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed embodiment(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the embodiment(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, if a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but not limited thereto. For example, the system may include one or more server devices. In another example, the system may include one or more cloud devices. In still another example, the system may include both the server device and the cloud device operated in conjunction with each other.

In the present disclosure, the “machine learning model” may include any model that is used for inferring an answer to a given input. The machine learning model may include an artificial neural network model including an input layer, a plurality of hidden layers, and an output layer. Each layer may include a plurality of nodes. In addition, in the present disclosure, the machine learning model may refer to an artificial neural network model, and the artificial neural network model may refer to the machine learning model. In addition, the machine learning model may be referred to as a model, and the model may refer to a machine learning model.

In the present disclosure, “each of a plurality of A” may refer to each of all components included in the plurality of A, or may refer to each of some of the components included in a plurality of A. For example, each of the plurality of data items may refer to each of all data items included in the plurality of data items or may refer to each of some data items included in the plurality of data items. Similarly, each of a plurality of label distributions may refer to each of all label distributions included in the plurality of label distributions or refer to each of some label distributions included in the plurality of label distributions.

In this disclosure, “data” may refer to a data item, and “data item” may refer to data.

In the present disclosure, “time series data” may refer to data having successive information over time. That is, it may include data (e.g., stock price information, exchange rate information, and the like) measured over a predetermined time interval or indexed in order.

In the present disclosure, a “label” is any object target for training and/or inference, and for example, the label may include a price of a particular stock, a trend (e.g., UP class, STATIONARY class, DOWN class, and the like) and/or a difference from an input price, and the like.

In the present disclosure, “label distribution” or “distribution of labels” may refer to a distribution for a plurality of labels corresponding to time series data and/or training time series data. The label distribution or the distribution of labels may be determined according to each number of a plurality of labels.

In the present disclosure, the term “stock item” may refer to securities such as stocks, bonds, and derivatives (options, futures, and the like) that are subject to trading in the securities market, classified according to content and format. For example, in addition to the individual stock items, the stock items may include index-related items, industrial sector-related items, items for specific commodities (e.g., crude oil, agricultural products, gold, and the like), exchange rate-related items, and the like.

In the present disclosure, a “stock exchange” refers to a place where securities circulated in at least one country are traded, and refers to a brokerage agency that lists and trades securities issued by each company, government, or the like. The stock exchange may include a system of the stock exchange.

In the present disclosure, “order book (OB or limit order book; LoB)” or “order book data” may refer to data including information (bid price, quantity, and the like) on the bid price of the buyer in the securities market who wants to buy, and information (ask price, quantity, and the like) on the ask price of the seller who wants to sell. The order book or the order book data may include data in the table form.

In the present disclosure, the “Top of the Book (ToB)” may include information (price, quantity, and the like) on the highest bid price and information (price, quantity, and the like) on the lowest ask price.

In the present disclosure, an “image” may be used interchangeably with “data in tensor form”.

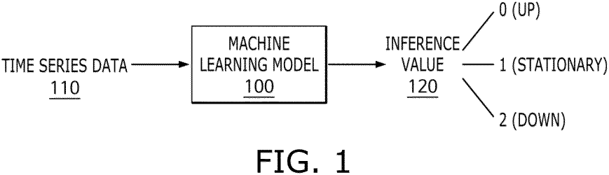

FIG. 1 is a schematic diagram illustrating an example of a system for outputting a prediction result using a machine learning model selected based on a data distribution. As illustrated, a machine learning model 100 may acquire or receive time series data 110. By the time series data 110, it may mean data having a temporal order. For example, the time series data 110 may include time series financial data, that is, data on stock items traded on a stock exchange. In addition, the training time series data may include data on stock items traded on a stock exchange collected in the past. For example, each of the time series data 110 and the training time series data may include 2D data (e.g., a 2D image) converted from data in table form for an order book of stock items traded on a stock exchange. In this case, the stock item associated with the time series data 110 may be the same as the stock item associated with the training time series data.

The time series data 110 may include a plurality of training time series data items and a plurality of training labels corresponding to the plurality of training time series data items. In this case, the plurality of training labels may refer to correct answer data used when training a machine learning model using a plurality of training time series data items. For example, each of the plurality of training time series data items may include 2D data according to time for a stock item on a stock exchange. In this case, the 2D data may be generated by processing an order book for a corresponding stock item acquired from a stock exchange. In this case, the plurality of training labels may include a first class (UP class) indicating that the price after a certain period of time (e.g., one of 100 ms to 1 sec) would increase from the price at the current time point, a second class (STATIONARY class) indicating that the price after a certain period of time would be the same as the price at the current time point, a third class (DOWN class) indicating that the price after a certain period of time would decrease from the price at the current time point, and the like.

In the case of time series financial data, because the data widely varies according to time and there is a vast amount of historical financial data that can be learned, it may be important to make inferences without reducing the performance of machine learning models. For this reason, it may be required to sample training data having various label distributions to train each machine learning model, and to select an optimal model from among a plurality of trained machine learning models. The machine learning model 100 may be selected from a plurality of machine learning models trained based on the training data having various label distributions. To this end, the information processing system (not illustrated) may generate a plurality of training label distributions in a variety of ways in the training data sampling process, and generate a plurality of machine learning models trained with various label distributions based on the same. The plurality of training label distributions and the plurality of trained machine learning models generated as described above may be stored in any storage medium (not illustrated).

The time series data 110 may include time series data in a test environment or in an actual inference environment, and a plurality of labels corresponding to past time points included in the time series data. In this case, a plurality of labels corresponding to the time series data may be extracted from the time series data, or converted and/or generated from the time series data. To this end, the information processing system may generate a label based on the price at each time point and the price after a certain period of time, from the order book data for the stock items (e.g., stocks) traded on the stock exchange. For example, like the training time series data, time series data in test environment or actual inference environment may include a plurality of labels corresponding to the time series data that may represent the first class (UP class), the second class (STATIONARY class), the third class (DOWN class), and the like. In this case, the distribution of the acquired plurality of labels may include a distribution for labels from a current time point to a past time point that is a certain period of time earlier, along the period of time included in the time series data. For example, if a plurality of labels are generated based on price information at a time point that is the certain period of time earlier than the current time point, the distribution of labels from the current time point to the past time point that is the certain period of time earlier may refer to a distribution for labels associated with each of the time points included in at least a portion of the remaining period except for the current time point.

The machine learning model 100 for generating a prediction result for the time series data 110 may be selected from among a plurality of machine learning models stored in advance, based on a degree of similarity between the time series data 110 and each of the training data learned by a plurality of machine learning models stored in advance. For example, a distance may be calculated between a plurality of training label distributions stored in advance and a plurality of label distributions included in the time series data 110 to determine a distribution having the closest distance. A machine learning model trained with the training data having the distribution selected as described above may be selected as the machine learning model 100 to output an inference value for the input data.

An inference value 120 at an inference time point may be output by inputting the time series data into the machine learning model 100. For example, as illustrated, the inference value 120 may be 0 indicating the UP class, 1 indicating the STATIONARY class, and 2 indicating the DOWN class. In this case, the inference value at the inference time point may refer to the inference value at a time point that is a predetermined period of time after the current time point. For example, the inference time point for the input data may be the same time point as the time point of the input data, or may be a time point that is a predetermined period of time after the time point of the input data. The inference time point may be the time point of the input data plus the time consumed by the information processing system to infer. Alternatively, the inference time point may be a time point offset to a time point at which the inference result has an increased accuracy.

In addition, the predetermined period added for the inference time point may be the same period as the predetermined period associated with the training label included in the training time series data. That is, the information processing system may use a label for a time point that is the result of adding a predetermined period of time to the current time point during the training process of the machine learning model 100, and output, through the generated model, an inference value for a time point that is the result of adding the input data with the same period of time as in the training process. This period of time may be adjusted to improve the accuracy of inference from a plurality of machine learning models stored in advance or from the selected machine learning model 100.

In FIG. 1, the inference values are illustrated in the UP class, the STATIONARY class, and the DOWN class, but aspects are not limited thereto, and the training labels and the inference values may be represented in 2 or less, or 4 or more classes. For example, the training labels and the inference values may include classes that represent sharp rises, slight rises, flat, slight declines, sharp declines, and the like. As another example, the training labels and the inference values may be represented with the data that indicates specific information rather than values classified into the classes.

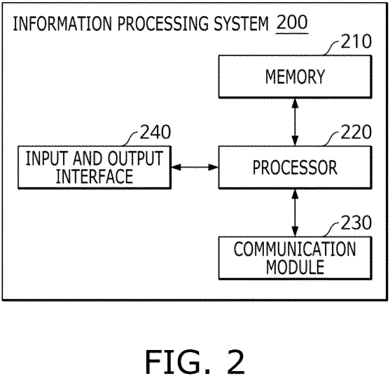

FIG. 2 is a block diagram of an information processing system 200 for selecting a machine learning model based on a data distribution. The information processing system 200 for selecting a machine learning model based on a data distribution may include a memory 210, a processor 220, a communication module 230, and an input and output interface 240. As illustrated in FIG. 2, the information processing system 200 may be configured to communicate information and/or data through a network by using the communication module 230.

The memory 210 may include any non-transitory computer-readable recording medium. The memory 210 may include a permanent mass storage device such as random access memory (RAM), read only memory (ROM), disk drive, solid state drive (SSD), flash memory, and so on. In another example, a non-destructive mass storage device such as ROM, SSD, flash memory, disk drive, and so on may be included in the information processing system 200 as a separate permanent storage device that is distinct from the memory. In addition, the memory 210 may store an operating system and at least one program code (for example, for calculation of the machine learning model installed and driven in the information processing system 200, pre-/post-processing, calculation of a plurality of label distributions, calculation of a plurality of training label distributions, calculation of a distance for model selection, and the like). In FIG. 2, the memory 210 is illustrated as a single memory, but this is only for convenience of description, and the processor 210 may include a plurality of memories.

These software components may be loaded from a computer-readable recording medium separate from the memory 210. Such a separate computer-readable recording medium may include a recording medium directly connectable to the information processing system 200, and may include a computer-readable recording medium such as a floppy drive, a disk, a tape, a DVD/CD-ROM drive, a memory card, and the like, for example. In another example, the software components may be loaded into the memory 210 through the communication module 230 rather than the computer-readable recording medium. For example, at least one program may be loaded into the memory 210 based on a computer program (e.g., a program or the like for distance calculation for model selection, transmission of price information for stock items on multiple stock exchanges, and the like) installed by the files provided by the developers, or by a file distribution system that distributes an installation file of an application through the communication module 230.

The processor 220 may be configured to process the commands of the computer program by performing basic arithmetic, logic, and input and output operations. The commands may be provided to a user terminal (not illustrated) or another external system by the memory 210 or the communication module 230. For example, the processor 220 may generate output data based on the input data using the machine learning model, and may generate order data of the stock items traded on the stock exchange, that is, buy or sell data based on the output data. The generated order data may be transmitted to the stock exchange system.

The communication module 230 may provide a configuration or function for the user terminal (not illustrated) and the information processing system 200 to communicate with each other through a network, and may provide a configuration or function for the information processing system 200 to communicate with an external system (e.g., a separate cloud system). For example, control signals, commands, data, and the like provided under the control of the processor 220 of the information processing system 200 may be transmitted to the user terminal and/or the external system through the communication module 230 and the network through the communication module of the user terminal and/or an external system. For example, an external system (e.g., a stock exchange system) may receive the order data (e.g., order book data, and the like), and the like from the information processing system 200.

In addition, the input and output interface 240 of the information processing system 200 may be a means for interfacing with a device (not illustrated) for inputting or outputting, which may be connected to the information processing system 200 or included in the information processing system 200. For example, the input and output interface 240 may include at least one of a PCI express interface and an Ethernet interface. In FIG. 2, the input and output interface 240 is illustrated as a component configured separately from the processor 220, but aspects are not limited thereto, and the input and output interface 240 may be configured to be included in the processor 220. The information processing system 200 may include more components than those illustrated in FIG. 2. Meanwhile, most of the related components may not necessarily require exact illustration.

The processor 220 of the information processing system 200 may be configured to manage, process, and/or store the information and/or data received from a plurality of user terminals and/or a plurality of external systems. The processor 220 may receive data including price information according to time for a stock item on the stock exchange. The processor may select an optimal model based on the received data and generate an inference value based on the selected model. In FIG. 2, the processor 220 is illustrated as a single processor, but this is only for convenience of description, and the processor 220 may include a plurality of processors. For example, the processor 220 may include one or more processors implemented in an FPGA for pre-processing and post-processing, and a dedicated accelerator implemented in an ASIC for a machine learning model, in which the one or more processors implemented in the FPGA may execute one or more instructions stored in a first memory, and the dedicated accelerator implemented in the ASIC may execute one or more instructions stored in a second memory.

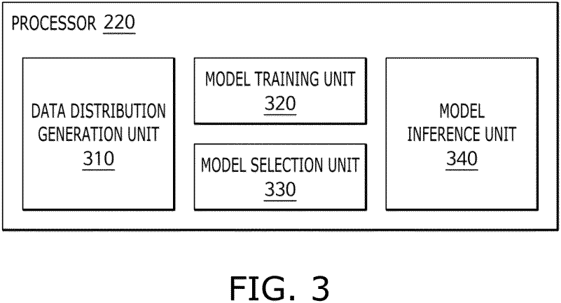

FIG. 3 is a diagram illustrating an internal configuration of the processor 220. The processor 220 may include a data distribution generation unit 310, a model training unit 320, a model selection unit 330, and a model inference unit 340. The respective components of the processor 220 illustrated in FIG. 3 represent functional components that can be divided on the basis of functions, and in an actual physical environment, a plurality of components may be implemented as being incorporated with each other. In addition, in FIG. 3, the processor 220 is implemented as including the separate components of the data distribution generation unit 310, the model training unit 320, the model selection unit 330, and the model inference unit 340, but aspects are not limited thereto, and some components may be omitted or other components may be added.

The data distribution generation unit 310 may acquire training data including a training time series data item and a plurality of training labels corresponding to the training time series data item, and generate, through a sampling technique, a distribution of labels corresponding to detailed training data items extracted from the acquired training data. In this case, the training label distributions can be arbitrarily adjusted and can be generated in advance. To this end, the data distribution generation unit 310 may oversample at least a portion of the detailed training data items to adjust the training label distribution or to match to a previously generated distribution of training labels, and generate the detailed training data items according to the corresponding label distribution. Additionally or alternatively, the data distribution generation unit 310 may undersample at least a portion of the detailed training data items to adjust the training label distribution or to match to a previously generated distribution of training labels, and generate the detailed training data items according to the corresponding label distribution. The generated distribution of labels may be stored in a storage medium (e.g., the memory 210, an external storage medium, and the like) together with the corresponding detailed training data items, or may be provided to the model training unit 320 and/or the model selection unit 330.

If the labels include the UP class, the STATIONARY class, or the DOWN class, a variety of distributions of labels may be generated by arbitrarily adjusting the number of UP classes, the number of STATIONARY classes, and/or the number of DOWN classes. In this case, the UP class may represent a class indicating a result predicting that the price of a stock item at a time point (future time point) that is a certain period of time earlier than the current time point would be higher than the price of the corresponding stock item at the current time point. In addition, the STATIONARY class may refer to a class indicating a result predicting that the price of the corresponding stock item at the current time point and the price of the corresponding stock item at the future time point would be the same or similar to each other. In addition, the DOWN class may represent a class indicating a result predicting that the price of the corresponding stock item at the future time point would be lower than the price of the corresponding stock item at the current time point. For example, distributions may be generated, including a distribution with the largest number of UP classes, a distribution with the largest number of STATIONARY classes, a distribution with the largest number of DOWN classes, a distribution with similarly large number of at least two classes of UP, STATIONARY, and DOWN, and so on.

In addition, the data distribution generation unit 310 may acquire time series data acquired at a current time point in the test environment or the actual inference environment and a plurality of labels corresponding to the time series data, and generate, from the acquired plurality of labels, a distribution for a plurality of labels from a current time point to a past time point that is a predetermined period of time earlier. The generated plurality of label distributions may be provided to the model selection unit 330.

The model training unit 320 may use the training time series data to train the machine learning model. The model training unit 320 may use, from the data distribution generation unit 310 and/or the storage medium, a plurality of training labels corresponding to the detailed training data item and the detailed training data item having each of the plurality of training label distributions to train each of a plurality of machine learning models. The plurality of machine learning models trained as described above may be stored in a storage medium and accessed by the model selection unit 330 and/or the model inference unit 340.

The model selection unit 330 may acquire a plurality of training label distributions corresponding to the trained plurality of machine learning models and a plurality of label distributions corresponding to the time series data. The model selection unit 330 may select at least one machine learning models from among the plurality of trained machine learning models based on a difference between each of the plurality of training label distributions and the plurality of label distributions. For example, by calculating a distance between each of the plurality of training label distributions and the plurality of label distributions, at least one machine learning model may be selected. The at least one machine learning models selected as described above may be provided to the model inference unit 340 or stored in a storage medium.

The model inference unit 340 may input the time series data into at least one selected machine learning model and output a prediction result (e.g., an inference value) at an inference time point. If the time series data includes data including price information according to time for a stock item on the stock exchange, the inference value at the inference time point may be a value indicating a difference between the price of the stock item at a time point point (future time point) that is a certain period of time earlier than the current time point and the price at the current time point. In this case, the inference value may be represented in the same format and content as the training label. The prediction results (e.g., inference values) generated as described above may be used to generate order data for the corresponding stock item on the stock exchange.

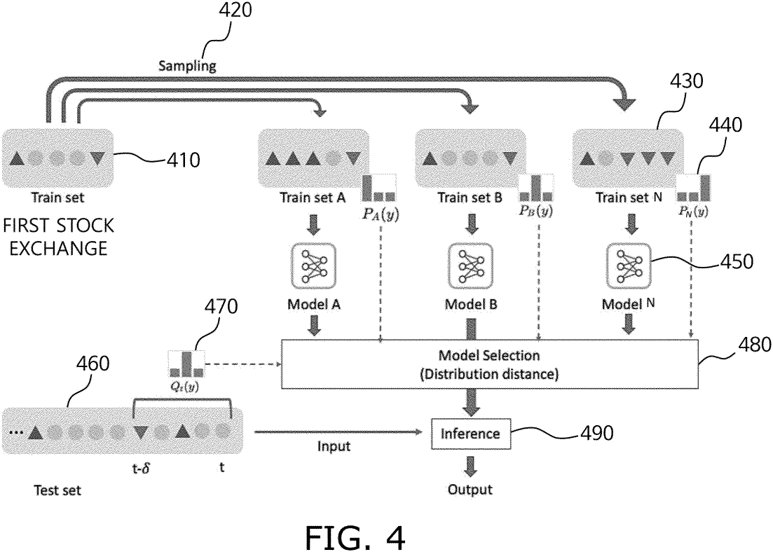

FIG. 4 is a diagram illustrating an example of selecting a machine learning model based on a data distribution and generating an inference result using the selected machine learning model. The machine learning model may acquire or receive training data 410. In this case, the training data 410 may include a training time series data item and a plurality of training labels corresponding to the training time series data item. For example, the training data 410 may include time series financial data, that is, data on stock items traded on the first stock exchange collected in the past. Specifically, the training time series data may include 2D data (images) converted from the order book data in table form.

By sampling 420 the training data 410, a train set having various training label distributions may be generated. For example, by sampling at least a portion of the plurality of detailed training data items from the training data 410 into train sets (e.g., Train set A, Train set B, and Train set N), a plurality of training label distributions (e.g., training label distributions P_{A}, P_{B}, and P_{N}) may be determined. In this case, the plurality of detailed training data items may be at least a portion of the data items forming the training data 410, and may be data at a specific time point or for a period of time in the time series data having a temporal order, which may include a label corresponding to each of the data at the specific time point or for the period of time. For example, the plurality of detailed training data items may be information on a bid/ask price or quantity of a prospective buyer/seller of a specific stock item at a specific time point or for a period of time in the time series securities data. In addition, a training label distribution may be determined according to the number of labels corresponding to each of the plurality of detailed training data items. As an example, as illustrated, Train set N including a plurality of detailed training data items sampled from the training data 410 extracted from the first stock exchange may include a plurality of detailed training labels 430. The training label distribution P_{N} 440 may be determined based on the number of the plurality of training detail labels 430 included in Train set N. Likewise, the training label distributions P_{A} and P_{B} may be determined based on the number of a plurality of training detail labels included in each of Train set A and Train set B.

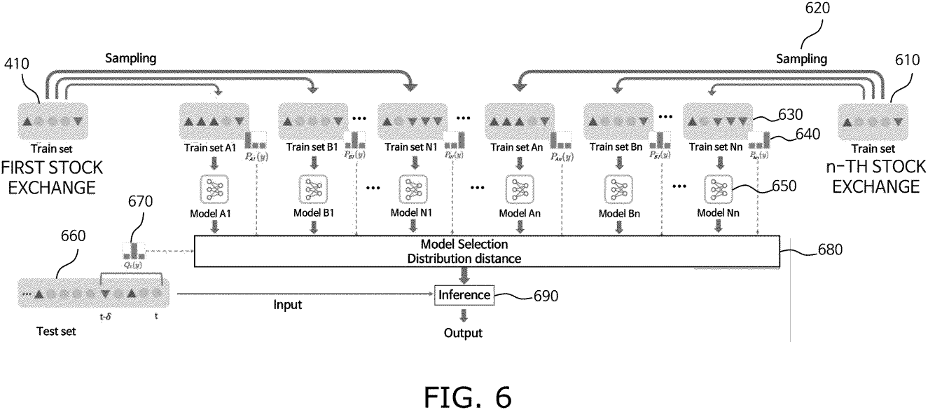

The information processing system may generate a train set having various training label distributions by sampling the training data including a plurality of market data. In this case, the plurality of market data may include past data of the inference target and past data of data related to the inference target. A plurality of training models may be trained by sampling such a plurality of market data according to the training label distribution, which will be described in detail elsewhere below with reference to FIG. 6.

The training label distribution determined based on the number of detailed training labels corresponding to each of the plurality of detailed training data items may be adjusted to a desired training label distributions. For example, the detailed training label Δ corresponding to the training time series data item may indicate an UP class indicating a result predicting that the price of the corresponding stock item at a time point (future time point) that is a certain period of time earlier than the current time point would be higher than the price of the stock item in the first stock exchange at the current time point. In addition, the training detail label · corresponding to the training time series data item may refer to a STATIONARY class indicating a result predicting that the price of the corresponding stock item at the current time point and the price of the corresponding stock item at the future time point would be the same or similar to each other. In addition, the training detail label · corresponding to the training time series data item may indicate a DOWN class indicating a result predicting that the price of the corresponding stock item at a future time point would be lower than the price of the corresponding stock item at the current time point. With such a configuration, by arbitrarily adjusting the number of UP classes, the number of STATIONARY classes, and/or the number of DOWN classes, various label distributions can be generated. In this case, the given training label distribution may be adjusted to a desired training label distribution by oversampling at least a portion of the plurality of detailed training data items from the training data 410. For example, the given training label distribution may be adjusted to a distribution with the largest number of UP classes, a distribution with the largest number of STATIONARY classes, a distribution with the largest number of DOWN classes, a distribution with similarly large number of at least two classes of UP classes, STATIONARY classes, and DOWN classes, and so on.

The processor may use the plurality of sampled detailed training data items and the plurality of detailed training labels corresponding to the plurality of detailed training data items to train each of the plurality of machine learning models. Three machine learning models, that is, Model A, model B, and Model N corresponding to a plurality of training label distributions P_{A}, P_{B}, and P_{N} may be trained. For example, the processor may generate a machine learning model 450 by using Train set N having the training label distribution P_{N} 440. In a similar manner, the processor may generate machine learning models A and B by using Train sets A and B with the training label distributions P_{A} and P_{B}. In FIG. 4, three sets of detailed training data and three machine learning models are illustrated for convenience of explanation, but aspects are not limited thereto, and any number of sets of detailed training data and machine learning models using the same may be generated.

The processor may acquire the time series data acquired at the current time point and a plurality of labels 460 corresponding to the time series data, and generate a distribution for at least a portion of the acquired plurality of labels. In this case, a distribution Qₜ 470 for at least a portion of the acquired plurality of labels may include a distribution for the labels from the current time point (t) to the past time point (t-δ) that is the predetermined period of time (δ) earlier. Further, the predetermined period of time (δ) may be adjusted to improve accuracy for inferences from at least some of the plurality of machine learning models.

The processor may acquire a plurality of training label distributions (P_{A}, P_{B}, and P_{N}) corresponding to a plurality of trained machine learning models (Models A, B and N) and a plurality of label distributions Qₜ 470 corresponding to the time series data. The processor may select at least one machine learning model 480 from among the plurality of trained machine learning models based on a difference between each of the plurality of training label distributions and the plurality of label distributions Qₜ 470. For example, by calculating a distance between each of the plurality of training label distributions and the plurality of label distributions Qₜ 470, at least one machine learning model 480 may be selected. In this case, as a method for measuring the distance between two label distributions, various techniques may be used such as, for example, techniques such as Jensen-Shannon divergence, Bhattacharyya distance, Wasserstein metric, Mahalanobis distance, and the like, but are not limited thereto.

The processor may select a machine learning model from among the plurality of trained machine learning models, which has a training label distribution having the closest calculated distance to the plurality of label distributions Qₜ 470. In another example, the processor may select, from among the plurality of trained machine learning models, a plurality of machine learning models that have close calculated distances to the plurality of label distributions Qₜ 470.

The processor may output an inference result 490 at the inference time point by inputting the time series data into at least one selected machine learning model. For example, if the time series data includes data including price information according to time for a stock item on the stock exchange, the inference result at the inference time point may be information indicating a difference between the price of the stock item at a time point point (future time point) that is a certain period of time earlier than the current time point and the price at the current time point. In this case, the inference result may be represented in the same format and content as the training detail label. The inference result may be represented with a value expressing Δ, O, or ∇ indicating each of the UP class, the STATIONARY class, or the DOWN class. In another example, if the selected machine learning model is a plurality of machine learning models, a plurality of inference results may be output.

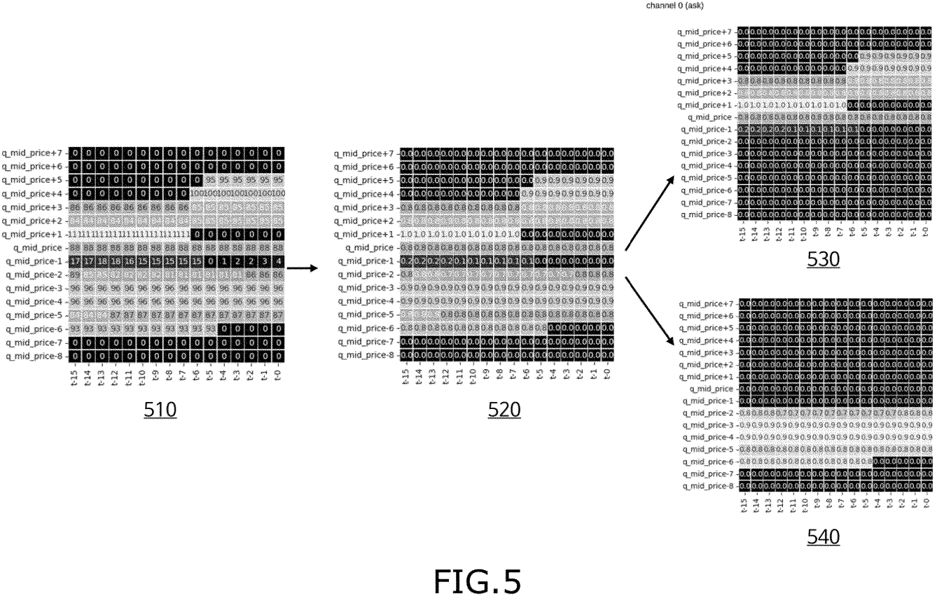

FIG. 5 is a diagram illustrating examples of training time series data and time series data. Each of the training time series data item and the time series data may include data in tensor form. Data in tensor form may include 2D data having, on the X-axis, times at certain time interval (e.g., unit time) and, on the Y-axis, prices in units (e.g., prices in units of tick), and including data for each quantity of a plurality of bid prices of a stock item on the stock exchange as values for each of a plurality of coordinates defined according to the times on the X-axis and the prices on the Y-axis, and 2D data having data for each quantity of a plurality of ask prices of a stock item on the stock exchange as values for each of a plurality of coordinates defined according to the times on the X-axis and the prices on the Y-axis. In this case, 2D data may refer to a 2D image. As illustrated in FIG. 5, the X-axis is represented in unit time and the Y-axis is represented as the prices in units of tick, but aspects are not limited thereto, and 2D data may be configured with inverted X-axis and Y-axis.

For example, as illustrated, the X-axis of the 2D image is represented as 16 unit times from the current time point, and the Y-axis of the 2D image is represented as the prices in units of tick in which the price in units of tick includes a mid price. In this case, the mid price may refer to an intermediate value between the highest price of the bid prices and the lowest price of the ask prices.

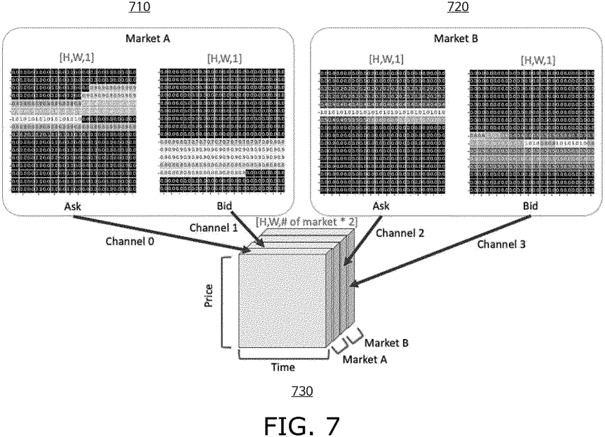

As illustrated, the quantity included in the coordinates (e.g., pixels) where the X-axis and the Y-axis included in a 2D image 510 meet may be normalized, and 2D data 520 including the normalized quantity may be divided into a 2D image 530 including only the normalized quantity for the bid price according to the price in units of tick, and a 2D image 540 including only a normalized quantity for only an ask price according to a price in units of tick. Each of the 2D images 530 and 540 may be configured as one separate channel to generate a tensor, and the internal configuration of the tensor will be described in detail elsewhere below with reference to FIG. 7.

FIG. 6 is a diagram illustrating an example of selecting a machine learning model using a label distribution with respect to at least one stock item in a plurality of stock exchanges and generating an inference result using the selected machine learning model. FIG. 6 illustrates an example with a plurality of stock exchanges, which is different from FIG. 4 described above with one stock exchange. In the following description, the configuration of the configurations of FIG. 6 already described above with reference to FIG. 4 is omitted.

Each of the training data and the time series data may include data in tensor form including a plurality of 2D data according to time for at least one stock item on each of a plurality of stock exchanges. Through this, the machine learning model may be selected based on the data distribution of a plurality of stock exchanges rather than a single stock exchange. For example, data including price information on at least one stock item of a plurality of stock exchanges (that is, the first to n-th stock exchanges, where n is a natural number equal to or greater than 2) may include a 2D image converted from order book data acquired from a plurality of stock exchanges.

The machine learning model may sample the training data 410 and 610 acquired from the first to n-th stock exchanges (where, n is a natural number equal to or greater than 2) to generate a train set having a label distribution. In this case, instead of generating a train set for each stock exchange, a channel may be allocated for each stock exchange, and the train set may be configured in such a way that the training data corresponding to each stock exchange is concatenated in the channel direction. For example, by sampling at least a portion of the plurality of detailed training data items from the training data 410 and 610 as a train set (e.g., Train set A, Train set B, and Train set N), a plurality of training label distributions (e.g., training label distributions of P_{A}, P_{B}, and P_{N}) may be determined. In this case, as illustrated in FIG. 6, a plurality of training label distributions (e.g., training label distributions of P_{A}, P_{B}, and P_{N}) may be generated by sampling the training data 410 acquired from the first stock exchange. That is, the plurality of training label distributions may be determined according to a label associated with the training data 410 of the first stock exchange. Alternatively, the plurality of training label distributions (e.g., training label distributions of P_{A}, P_{B}, and P_{N}) may be generated by sampling the training data acquired from not only the first stock exchange but also from at least two stock exchanges of the first to n-th stock exchanges (where n is a natural number equal to or greater than 2). That is, the plurality of training label distributions may be determined according to labels associated with the training data of at least two stock exchanges.

As illustrated in FIG. 4, the plurality of detailed training data items may represent at least a portion of data items forming the acquired training data 410 and 610, and a training label distribution may be determined according to the number of labels corresponding to each of the plurality of detailed training data items. As an example, as illustrated, Train set N including a plurality of detailed training data items sampled from the training data 410 and 610 extracted from the first stock exchange to the n-th stock exchange may include a plurality of detailed training labels 630. The training label distribution P_{Nn} 640 may be determined based on the number of the plurality of training detail labels 630 included in Train set Nn. Likewise, the training label distributions P_{A} and P_{B} may be determined based on the number of a plurality of training detail labels included in each of Train set A and Train set B.

In the case of a plurality of stock exchange data, unlabeled stock exchange data may be used for training. For example, as illustrated in FIG. 6, only the first stock exchange data may have a label, and the n-th stock exchange data may not have a label. In FIG. 6, symbols (e.g., Δ, O, ∇, and the like) are used to express labels (e.g., labels indicating trends, UP class, STATIONARY class, DOWN class, and the like).

The processor may use the plurality of sampled detailed training data items and the plurality of detailed training labels corresponding to the plurality of detailed training data items sampled from the training data 410 and 610 to train each of the plurality of machine learning models. Three machine learning models, that is, Model A, model B, and Model N corresponding to a plurality of training label distributions P_{A}, P_{B}, and P_{N} may be trained. For example, the processor may generate a machine learning model 650 by using Train set Nn having the training label distribution P_{Nn} 640. In a similar manner, the processor may generate machine learning models A and B by using Train sets A and B with the training label distributions P_{A} and P_{B}. In FIG. 6, only three sets of detailed training data acquired from the training data 410 and 610 and three machine learning models trained using them are illustrated for convenience of explanation, but aspects are not limited thereto, and any number of sets of detailed training data and machine learning models using the same may be generated.

The processor may acquire the time series data acquired at the current time point and a plurality of labels 660 corresponding to the time series data, and generate a distribution for at least a portion of the acquired plurality of labels. In this case, a distribution Qₜ 670 for at least a portion of the acquired plurality of labels may include a distribution for the labels from the current time point (t) to the past time point (t-δ) that is the predetermined period of time (δ) earlier. In this case, the predetermined period of time (δ) may be adjusted to improve accuracy for inferences from at least some of the plurality of machine learning models.

The processor may acquire a plurality of training label distributions (P_{A}, P_{B}, and P_{N}) corresponding to a plurality of machine learning models (Models A, B, and N) trained using a train set generated from a plurality of detailed training data items extracted from a plurality of stock exchanges (i.e., (n) stock exchanges) and a plurality of label distributions Qₜ 670 corresponding to time series data. The processor may select at least one machine learning model from among the plurality of machine learning models trained from the (n) stock exchanges, based on a difference between each of the plurality of training label distributions and the plurality of label distributions Qₜ 670. For example, by calculating the distance between each of the plurality of training label distributions and the plurality of label distributions Qₜ 670, a machine learning model trained by the training label distribution from among the plurality of training label distributions that has the closest calculated distance to the plurality of label distributions Qₜ 670 corresponding to time series data, may be selected.

The processor may output an inference result 690 at the inference time point by inputting the time series data into at least one selected machine learning model. If the time series data includes data including price information according to time for at least one stock item on each of a plurality of stock exchanges, the inference result at the inference time point may be a value representing the difference between the price of the stock item traded in each stock exchange at a time point (future time point) that is a certain period of time earlier than the current time point and the price at the current time point. In this case, the inference value may be represented in the same format and content as the training label. According to another example, if the time series data includes data including price information according to time for at least one stock item on one or more stock exchanges of a plurality of stock exchanges, the inference result at the inference time point may be a value representing the difference between the price of the stock item traded in one or more stock exchange at a time point (future time point) that is a certain period of time earlier than the current time point and the price at the current time point.

As described above, training based on the data from a plurality of stock exchanges rather than a single stock exchange may allow the stock price trends in various stock exchanges to be reflected when generating a prediction result (inference value) for at least one stock item, because the price information on at least one stock item on the plurality of stock exchanges is used for training the machine learning model.

FIG. 7 is a diagram illustrating examples of training time series data and time series data for at least one stock in a plurality of stock exchanges. Each of the training data and the time series data may include data in tensor form including a plurality of 2D data according to time for at least one stock item on each of a plurality of stock exchanges. In this case, the data in tensor form may include 2D data having, on the X-axis, times at certain time interval (e.g., unit time) and on the Y-axis, prices in units (e.g., prices in units of tick), in which the 2D data may include data for each quantity of a plurality of bid prices of a stock item on one stock exchange (Market A) as values for each of a plurality of coordinates defined according to the times on the X-axis and the prices of the Y-axis, and 2D data having data for each quantity of a plurality of ask prices of a stock item on the one stock exchange (Market A) as values for each of a plurality of coordinates defined according to times on the X-axis and the prices on the Y-axis. That is, a plurality of 2D data 710 corresponding to at least one stock item on Market A may be generated. In a similar manner, a plurality of 2D data 720 for a corresponding stock item on another stock exchange (Market B) may be generated.

Data 730 in tensor form may include the plurality of 2D data 710 and 720 corresponding to each of a plurality of stock exchanges. In this case, as illustrated, the data 730 in tensor form may have the same X and Y axes as the X and Y axes of the 2D data, and may have a channel on the Z-axis. In addition, each of the plurality of 2D data formed of the X and Y axes may be allocated to each channel on the Z-axis. As described above, if the data of a plurality of stock exchanges are stacked and merged, location information on the horizontal axis and the vertical axis may be identically aligned. That is, by comparing the distribution of the training data and the distribution of the time series data in a plurality of market data in consideration of the same time and the same price level, an optimal machine learning model may be selected.

The data that can be allocated to each channel of the Z axis may include not only data of a plurality of stock exchanges, but also a plurality of 2D data corresponding to a plurality of stock items or related market information. For example, while the stock item as a training target and the stock item as an inference target may be the same, it is also possible that a specific stock item may be inferred using different stock items or related market information. In this case, each of the plurality of 2D data corresponding to the plurality of stock items may be allocated to each channel of the Z axis.

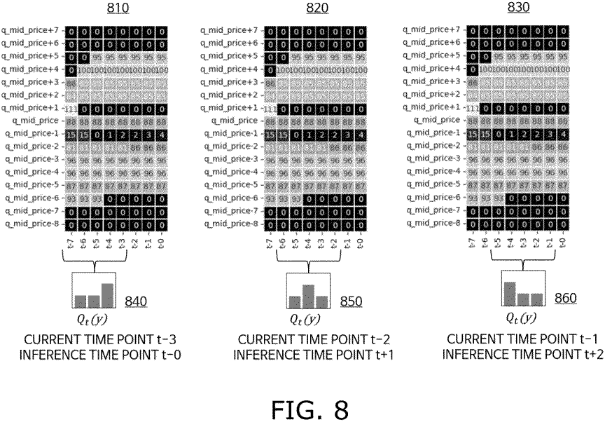

FIG. 8 is a diagram illustrating an example of time series data in which a distribution of labels continuously changes according to time. The processor (e.g., the processor of an information processing system 120) may repeatedly generate data on the stock items on the stock exchange as time changes. In this case, the data on the stock item on the stock exchange may include 2D images 810, 820, and 830 and a plurality of labels corresponding to the 2D images 810, 820, and 830. In addition, the processor may sequentially generate a plurality of label distributions 840, 850, and 860 by using the plurality of labels corresponding to the 2D images 810, 820, and 830.

As the current time point changes, a plurality of labels from the changed current time point to a past time point that is the predetermined period of time earlier may be repeatedly generated. For example, the time series data may include each of a plurality of labels corresponding to the time series data, and a plurality of label distributions Qₜ may include a distribution for labels from the current time point (t) to the past time point (t-δ) that is the predetermined period of time (δ) earlier. In this case, as the current time point (t) continues to move, the labels for each time point may also change, and the plurality of label distributions Qₜ may also change. Accordingly, the processor may repeatedly generate, at every time point, a plurality of labels from the current time point (t) to the past time point (t-δ) that is the predetermined period of time (δ) earlier.

As illustrated in FIG. 8, in the 2D data at the current time point, the distribution of the labels at each time point also changes as the current time point continues to change. For example, the distribution 840 of labels from time point (t-3) to a certain past time point may be changed such that the number of DOWNs is highest, the distribution 850 of labels from time point (t-2) to a certain past time point may be changed such that the number of STATIONARYs is highest, and the distribution 860 of labels from time point (t-1) to a certain past time point may be changed such that the number of UPs is highest. The labels considered at each time point include labels from a time point that is 7 ticks before each inference time point to a time point that is 3 ticks before each time point. In this case, it can be assumed that the label of each time point can be determined by looking at the price after the next 3 ticks. For example, the label at time point (t-3) may be determined by comparing the price at time point (t-3) with the price at time point (t) or with a time point that is a predetermined period of time after the time point (t).

The processor may select one or more machine learning models from among the plurality of machine learning models based on the degree of similarity (e.g., difference, distance, and the like) between the repeatedly generated plurality of label distributions and each of the plurality of training label distributions. For example, at the current time point (t-3), a model trained based on the training label distribution similar to the label distribution 840 at the time point (t-3) may be selected. At the current time point (t-2), a model trained based on the training label distribution similar to the label distribution 850 at the time point (t-2) may be selected. That is, a machine learning model may also be repeatedly selected based on the plurality of label distributions repeatedly generated at every time point, and a price after 3 ticks may be inferred using the model selected at every time point. In this case, the time point of inferring the price after 3 ticks may be the time point that is added with the time consumed by the model inference unit for inferring, or may be an offset time point at which the accuracy of the inference result is increased.

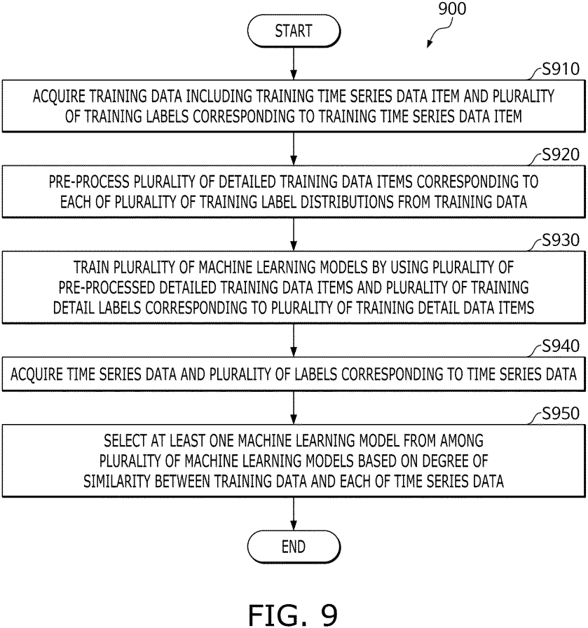

FIG. 9 is a flowchart illustrating an example of a method 900 for selecting a machine learning model based on a data distribution. The method 900 may be initiated by one or more processors (e.g., the processor 220 of the information processing system 120) acquiring the training data including the training time series data item and a plurality of training labels corresponding to the training time series data item, at S910. In this case, the training time series data may include data on stock items traded on the stock exchange.

The processor may pre-process the plurality of detailed training data items corresponding to each of the plurality of training label distributions from the training data, at S920. The plurality of training label distributions may be determined by oversampling at least a portion of the plurality of detailed training data items from the training data. In this case, the plurality of training label distributions may be predetermined or adjusted. For example, after a plurality of detailed training data items are extracted, training label distributions corresponding to the plurality of detailed data items may be calculated, in which case at least a portion of the plurality of extracted detailed training data may be oversampled according to a desired training label distribution. In addition, when at least a portion of the plurality of detailed training data items is oversampled, at least a portion of the plurality of detailed training data items may be augmented such that a corresponding training label distribution may be adjusted. For example, at least a portion of the detailed training data items may be augmented by modifying a buy/sell order price according to time included in the at least a portion of the detailed training data items, such that the training label distributions acquired by sampling from the training data is similar to the label distributions in the actual inference environment.

The processor may train the plurality of machine learning models by using the plurality of pre-processed detailed training data items and the plurality of detailed training labels corresponding to the plurality of detailed training data items, at S930. The processor may use a plurality of training labels corresponding to the detailed training data item and the detailed training data item having each of the plurality of training label distributions to train each of a plurality of machine learning models.

The time series data and the plurality of labels corresponding to the time series data may be acquired by the processor, at S940. It is possible to acquire time series data acquired at a current time point and a plurality of labels corresponding to the time series data, and generate, from the acquired plurality of labels, a distribution for a plurality of labels from a current time point to a past time point that is a predetermined period of time earlier.

The processor may select at least one machine learning model from among the plurality of machine learning models based on the degree of similarity between the training data and each of the time series data, at S950. The processor may acquire a plurality of training label distributions corresponding to the trained plurality of machine learning models and a plurality of label distributions corresponding to the time series data. The processor may determine, from among the plurality of trained machine learning models, a difference between the plurality of training label distributions and the plurality of label distributions as a degree of similarity between the training data and each of the time series data. The processor may select at least one machine learning model based on the determined degree of similarity. For example, the processor may calculate the distance between each of the plurality of training label distributions to select a machine learning model having a training label distribution of a plurality of training label distributions that has the closest calculated distance to the plurality of label distributions corresponding to the time series data. As still another example, the processor may calculate a reciprocal number of the distance between each of the plurality of training label distributions, and select a machine learning model from among a plurality of training label distributions that has a training label distribution having the calculated reciprocal number of the distance farthest away from the plurality of label distributions corresponding to the time series data. The processor may output an inference value at an inference time point based on the time series data using the selected at least one machine learning model.

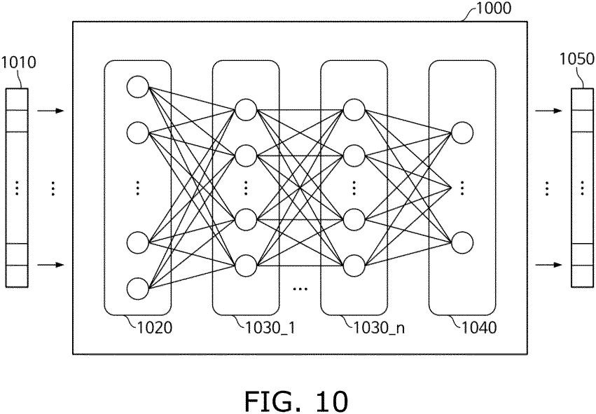

FIG. 10 illustrates an example of a machine learning model 1000. In machine learning technology and cognitive science, the artificial neural network model 1000 as an example of the machine learning model refers to a statistical learning algorithm implemented based on a structure of a biological neural network, or to a structure that executes such algorithm.

The artificial neural network model 1000 may represent a machine learning model that acquires a problem solving ability by repeatedly adjusting the weights of synapses by the nodes that are artificial neurons forming the network through synaptic combinations as in the biological neural networks, thus training to reduce errors between a target output corresponding to a specific input and a deduced output. For example, an artificial neural network model 1000 may include any probability model, neural network model, and the like, that is used in artificial intelligence learning methods such as machine learning and deep learning.

The artificial neural network model 1000 may include an artificial neural network model configured to use input data generated based on time series data for a stock item traded on one or more stock exchanges to output, as an inference value, data associated with an order of the corresponding stock item on the stock exchange.

The artificial neural network model 1000 is implemented as a multilayer perceptron (MLP) formed of multiple nodes and connections between them. The artificial neural network model 1000 may be implemented using one of various artificial neural network model structures including the MLP. As illustrated in FIG. 10, the artificial neural network model 1000 includes an input layer 1020 to receive an input signal or data 1010 from the outside, an output layer 1040 to output an output signal or data 1050 corresponding to the input data, and (n) number of hidden layers 1030_1 to 1030_n (where n is a positive integer) positioned between the input layer 1020 and the output layer 1040 to receive a signal from the input layer 1020, extract the features, and transmit the features to the output layer 1040. In an example, the output layer 1040 receives signals from the hidden layers 1030_1 to 1030_n and outputs them to the outside.

The method of training the artificial neural network model 1000 includes the supervised learning that trains to optimize for solving a problem with inputs of teacher signals (correct answers), and the unsupervised learning that does not require a teacher signal. The artificial neural network model 1000 may be trained by the supervised and/or unsupervised learning to output an inference value at an inference time point based on time series data. In this case, the inference value may include a prediction result (e.g., price prediction information at a future time point point when a trade order to the stock exchange is possible) for information (e.g., a specific stock item on the stock exchange) included in the time series data. For example, the artificial neural network model 1000 may be trained by the supervised and/or unsupervised learning to output an inference value at an inference time point by using a plurality of sampled detailed training data items and a plurality of detailed training labels corresponding to the plurality of detailed training data items.

The artificial neural network model 1000 learned as described above may be stored in the memory of the information processing system 200 or in the memory (not illustrated) of the device for selection of a machine learning model based on a data distribution, and infer the data associated with the stock order in the stock exchange in response to the input of data received from the communication module and/or memory.

The input data of the artificial neural network model for outputting an inference value at an inference time point based on time series data may include one or more input features for one or more stock items at one or more time points. For example, the input data input to the input layer 1020 of the artificial neural network model 1000 may be a vector 1010 in which data including information on one or more input features for one or more items at one or more time points is configured as one vector data element. In response to the input of data, output data output from the output layer 1040 of the artificial neural network model 1000 may be a vector 1050 representing or characterizing an inference value at an inference time point based on time series data. That is, the output layer 1040 of the artificial neural network model 1000 may be configured to output a vector representing or characterizing an inference value at an inference time point based on time series data. In the present disclosure, the output data of the artificial neural network model 1000 is not limited to the type described above, and may include any information/data representing an inference value at an inference time point based on time series data.

As described above, the input layer 1020 and the output layer 1040 of the artificial neural network model 1000 are respectively matched with a plurality of output data corresponding to a plurality of input data, and the synaptic values between nodes included in the input layer 1020, and the hidden layers 1030_1 to 1030_n, and the output layer 1040 are adjusted, so that training can be processed to extract a correct output corresponding to a specific input. Through this training process, the features hidden in the input data of the artificial neural network model 1000 may be confirmed, and the synaptic values (or weights) between the nodes of the artificial neural network model 1000 may be adjusted so as to reduce the errors between the output data calculated based on the input data and the target output. The artificial neural network model 1000 trained as described above may output an inference value at an inference time point in response to the input time series data.

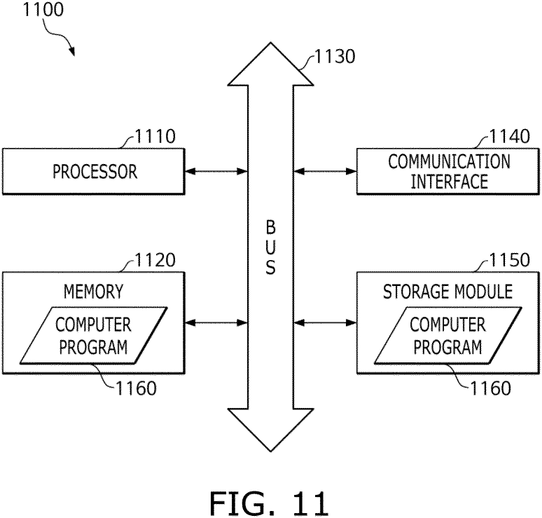

FIG. 11 is a configuration diagram of a computing device that trains a machine learning model and outputs an inference value using the machine learning model selected based on a distribution of labels. For example, a computing device 1100 may include the information processing system 200 and/or the user terminal (not illustrated). As illustrated, the computing device 1100 may include one or more processors 1110, a bus 1130, a communication interface 1140, a memory 1120 for loading a computer program 1160 to be executed by the processors 1110, and a storage module 1150 for storing the computer program 1160. Meanwhile, only the components related to the present example are illustrated in FIG. 11. Accordingly, those of ordinary skill in the art to which the present disclosure pertains will be able to recognize that other general-purpose components may be further included in addition to the components illustrated in FIG. 11.

The processors 1110 control the overall operation of each component of the computing device 1100. The processor 1110 may include central processing unit (CPU), micro processor unit (MPU), micro controller unit (MCU), graphic processing unit (GPU), neural processing unit (NPU), or any type of processor well known in the technical field of the present disclosure. In addition, the processors 1110 may perform an arithmetic operation on at least one application or program for executing the method according to various examples. The computing device 1100 may include one or more processors. For example, the computing device 1100 may include a processor implemented in an FPGA, and a dedicated accelerator for a machine learning model implemented in an ASIC (NPU ASIC).

The memory 1120 may store various types of data, instructions, and/or information. The memory 1120 may load one or more computer programs 1160 from the storage module 1150 in order to execute the method/operation according to various examples of the present disclosure. The memory 1120 may be implemented as a volatile memory such as RAM, but the technical scope of the present disclosure is not limited thereto.

The bus 1130 may provide a communication function between components of the computing device 1100. The bus 1130 may be implemented as various types of buses such as an address bus, a data bus, a control bus, or the like.

The communication interface 1140 may support wired/wireless Internet communication of the computing device 1100. In addition, the communication interface 1140 may support various other communication methods in addition to the Internet communication. To this end, the communication interface 1140 may include a communication module well known in the technical field of the present disclosure.

The storage module 1150 may non-temporarily store one or more computer programs 1160. The storage module 1150 may include a nonvolatile memory such as a read only memory (ROM), an erasable programmable ROM (EPROM), an electrically erasable programmable ROM (EEPROM), a flash memory, and the like, a hard disk, a detachable disk, or any type of computer-readable recording medium well known in the art to which the present disclosure pertains.

The computer program 1160 may include one or more instructions that, if loaded into the memory 1120, cause the processors 1110 to perform an operation/method in accordance with various examples of the present disclosure. That is, the processors 1110 may perform operations/methods according to various examples by executing one or more instructions.

For example, the computer program 1160 may include instructions for acquiring training data including a training time series data item and a plurality of training labels corresponding to the training time series data item, sampling a plurality of detailed training data items corresponding to each of a plurality of training label distributions from the training data. In addition, the computer program 1160 may further include instructions for training a plurality of machine learning models using the sampled plurality of detailed training data items and a plurality of detailed training labels corresponding to the plurality of detailed training data items, acquiring time series data and a plurality of labels corresponding to the time series data, and selecting at least one machine learning model from among a plurality of machine learning models, based on a difference between the distribution of the acquired plurality of labels and each of the plurality of training label distributions.

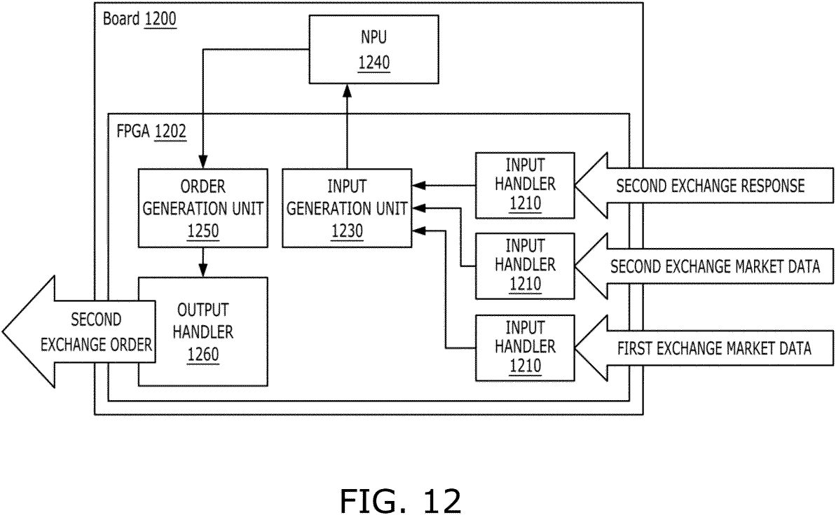

FIG. 12 is a diagram illustrating an internal configuration of a plurality of processors. FIG. 12 illustrates an example with a single processor, which is different from FIG. 3 described above with a plurality of processors, and the configuration of FIG. 12 already described above with reference to FIG. 3 is omitted. A processor 1200 may refer to a processor of a high-frequency stock trading device or a high-frequency stock order data generating device.

The processor 1200 may include one or more processors 1220 (e.g., one or more processors implemented in FPGA) for pre-/post-processing and a dedicated accelerator 1240 (e.g., a dedicated accelerator implemented as ASICs) for the machine learning model. The one or more processors 1220 for pre-/post-processing may include an input handler 1210, an input generation unit 1230, an order generation unit 1250, and an output handler 1260. Although the internal components of the processor are illustrated separately by function in FIG. 12, it should be noted that this does not necessarily mean that they are physically separated. In addition, the internal components of the processor illustrated in FIG. 12 are only an example, and it is not intended to depict essential configurations only. Accordingly, in some aspects, the processor may be implemented differently, such as by additionally including components other than those internal components illustrated, or by omitting some of the illustrated components.

The processor may receive time series data (e.g., market data) from one or more stock exchanges (e.g., a first stock exchange,..., an n-th stock exchange, where n is a natural number equal to or greater than 2). The one or more stock exchanges may include a target stock exchange. The received market data may include time series data on stock items traded in the one or more stock exchanges. For example, the market data may include an order book of (at least some of) stock items traded in a stock exchange, and additionally, the market data may include data on a target stock item. For example, the market data may include a top of an order book for the target stock item, a list of (valid) orders for the target stock item, the response of the target stock exchange (second stock exchange) to a previous order for the target stock item, and the like. The processor may receive the market data from the one or more stock exchanges every time the market data needs to be updated, or may receive time series data of the market data by periodically (e.g., every 0.1 seconds) receiving market data from one or more stock exchanges.

Since it is important to process data at a high speed in high frequency trading, the market data may be received through a User Datagram Protocol (UDP) having a high data transmission rate. However, in some aspects, other communication protocols (e.g., TCP/IP) may be used to receive market data as needed (e.g., to ensure reliability of data).

The input handler 1210 may parse and/or decode the received time series market data. The market data may be received in a plurality of data packets and may be received through a plurality of lines. If the market data is received through a plurality of lines, each input handler 1210 may parse and/or decode the market data received through the plurality of lines in different ways according to the data format or standard. The market data parsed/decoded through the input handler 1210 may be provided to the input generation unit 1230 to generate input data of the machine learning model. In this case, as described in FIG. 9, the machine learning model may be at least one machine learning model selected from among the plurality of machine learning models based on a degree of similarity between the training data of the machine learning model and the received time series data (herein, market data).

The input generation unit 1230 may generate input data based on at least a portion of the market data. The input generation unit 1230 may select one or more input features of one or more stock items from among the market data to form input data. For example, the input generation unit 1230 may include a feature extraction unit for extracting or selecting input features included in the input data.

One or more stock items included in the input data may include stock items that may be a leading indicator of a variation in market conditions of the target stock item. For example, if the target stock item to be ordered is the stock item (spot) of Company A, data on futures stock items related to company A’s stock item, option stock items related to company A’s stock item, stock items related to company A included in other exchanges, futures stock items for products (e.g., crude oil, and the like) associated with company A, and the like may be included in the input data. In addition, the one or more input features included in the input data may include information meaningful in predicting market conditions of the target stock item. For example, the input features may include various information extractable from the order book of one or more stock items, such as a market price (transaction price), a trend (e.g., UP class, STATIONARY class, DOWN class, and the like), a price difference from the input price, a price and quantity at the top of the order book of a buying side, a price and quantity at the top of the order book of a selling side, the number of sellers wishing to sell, the ask price for buy of the next stage at the top of the order book, the ask price for sell of the next stage at the top of the order book, the variance of the ask price included in the order book, and the like, information obtained by processing the information and/or reliability of the information, and the like. At least some of these input features may include a plurality of labels corresponding to the market data of the machine learning model.

The input data generated by the input generation unit 1230 may be transmitted to the dedicated accelerator 1240 for the selected at least one machine learning model, and may be input to the selected at least one machine learning model (e.g., DNN). The dedicated accelerator 1240 may be a neural processing unit (NPU) specialized for arithmetic processing of at least one machine learning model, and may be implemented as an application-specific semiconductor (ASIC) specialized for driving at least one machine learning model. The dedicated accelerator 1240 may use at least one machine learning model to derive output data associated with an order for a target stock item based on the input data. For example, the dedicated accelerator 1240 may input input data to the machine learning model, and derive output data, that is, an inference value that predicts a price (e.g., a market price or a mid price) of a target stock item at an inference time point (e.g., at a specific time point in the future). The specific time point in the future may be a time point obtained by the current time point plus a latency in ordering a stock to the second stock exchange. That is, it is possible to predict the price of the target item near the time point when the stock order is expected to arrive at the second stock exchange in consideration of the latency.

Instead of directly providing the input data generated by the input generation unit 1230 to the dedicated accelerator 1240 for at least one selected machine learning model, the processor (e.g., one or more processors for pre-/post-processing) may first determine whether or not to use at least one machine learning model, and transmit the input data to the dedicated accelerator 1240 for at least one machine learning model only when it is determined to use at least one machine learning model.

The order generation unit 1250 may receive the data output from the machine learning model, and generate the order data in the second stock exchange based on the output data. For example, the order generation unit 1250 may generate the order data for the target stock item according to a predetermined rule based on the predicted price of the target stock item at a future time point, which is inferred from at least one selected machine learning model. As a specific example, if the price of the target stock item is predicted to increase, the order generation unit 1250 may immediately generate a new bid order or correct the ask price of an existing ask order. The order data may include information on the type of order (new order, order cancellation, order correction), whether to buy or sell, price (ask price), quantity, and the like for the target stock item.

Additionally, the order data generated by the order generation unit 1250 may be transmitted to the output handler 1260. The output handler 1260 may check a risk based on the generated order data, or determine whether or not a regulation on market making is satisfied. Additionally or alternatively, the output handler 1260 may perform appropriate processing on the previously generated order data according to the format, standard, and protocol of the order data required by the second stock exchange.

The order data generated by the order generation unit 1250 (or post-processed by the output handler 1260) may be transmitted to the second stock exchange. The processor (e.g., one or more processors for pre-/post-processing) may receive a response of the second stock exchange to the transmitted order data. In this case, the processor may update the order details of the second stock exchange based on the received response, and the order details of the second stock exchange may be used as market data to create a next order, or may be used as basic data for the order generation unit 1250 to create an order.

FIG. 12 illustrates an example of using the market data of two stock exchanges to output an order of one of the exchanges, but aspects are not limited thereto, and it may be possible to use the market data of one exchange to output an order for that exchange, and use the market data of three or more exchanges to output an order for the market data of at least one exchange.

The method described above may be provided as a non-transitory computer-readable recording medium storing instructions for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method for selecting a machine learning model based on a data distribution, the method being performed by one or more processors and comprising:
acquiring training data set including training time series data and a plurality of training labels corresponding to the training time series data;
sampling the training data set to generate a plurality of detailed training data sets, wherein each of the plurality of detailed training data sets is associated with a respective one of a plurality of time periods and includes detailed training data belonging to an associated time period and a plurality of training labels corresponding to the detailed training data, and each of the plurality of detailed training data sets has a respective one of a plurality of training label distributions;
training a plurality of machine learning models using the plurality of detailed training data sets, wherein each of the plurality of machine learning models is associated with a respective one of the plurality of time periods and is trained by using a detailed training data set belonging to an associated time period;
acquiring time series data and a plurality of labels corresponding to the time series data;
determining a plurality of differences, wherein each of the plurality of differences is associated with a respective one of the plurality of time periods and is between the time series data and a detailed training data set belonging to an associated time period;
selecting at least one machine learning model from among the plurality of machine learning models based on the plurality of differences; and
outputting an inference value at an inference time point based on the time series data by using the selected at least one machine learning model.

2. The method according to claim 1, wherein each of the training time series data set and the time series data includes data including price information according to time for a stock item on a stock exchange.

3. The method according to claim 1, wherein each of the training time series data set and the time series data includes data in tensor form including:
2-dimensional (2D) data having, on an X-axis, values obtained by dividing a time by a unit time and having, on a Y-axis, values obtained by dividing the time by a unit price, the 2D data including data according to time of a quantity of each of a plurality of ask prices of a stock item on a stock exchange as values for each of a plurality of coordinates defined according to the time on the X-axis and the price on the Y-axis; and
2D data having data according to time of a quantity of each of a plurality of bid prices of a stock item on the stock exchange as values for each of a plurality of coordinates defined according to the X-axis and the Y-axis.

4. The method according to claim 1, further comprising:
determining each of the plurality of training label distributions by oversampling at least a portion of the plurality of detailed training data sets.

5. The method according to claim 4, wherein the determining each of the plurality of training label distributions includes, when oversampling the at least the portion of the plurality of detailed training data sets, augmenting at least a portion of the plurality of detailed training data sets.

6. The method according to claim 1, wherein a distribution of the acquired plurality of labels includes a distribution for labels from a current time point to a past time point that is a predetermined period of time earlier, and
the selecting the at least one machine learning model includes:
calculating a distance between the distribution for labels from the current time point to the past time point that is the predetermined period of time earlier and each of the plurality of training label distributions; and
selecting, from among the plurality of training label distributions, a machine learning model that has a training label distribution with a closest calculated distance to the distribution for labels from the current time point to the past time point that is the predetermined period of time earlier.

7. The method according to claim 6, wherein the predetermined period of time is adjusted to improve accuracy for inferences from the plurality of machine learning models.

8. The method according to claim 1, wherein the acquiring the time series data and the plurality of labels corresponding to the time series data includes, as a current time point changes, repeatedly generating a plurality of labels from the changed current time point to a past time point that is a predetermined period of time earlier, and
each of the plurality of differences is between the time series data including the repeatedly generated plurality of label distributions and detailed training data set including a training label distribution belonging to an associated time period.

9. The method according to claim 1, wherein each of the training data and the time series data includes data in tensor form including a plurality of 2D data according to time for at least one stock item on each of a plurality of stock exchanges.

10. (canceled)

11. A non-transitory computer-readable recording medium storing instructions that, when executed by one or more processors, cause performance of the method according to claim 1.

12. A system for selecting a machine learning model based on a data distribution, comprising:
a memory storing one or more instructions; and
one or more processors configured to execute the one or more instructions in the memory to:
acquire training data set including training time series data and a plurality of training labels corresponding to the training time series data;
sampling the training data set to generate a plurality of detailed training data sets, wherein each of the plurality of detailed training data sets is associated with a respective one of a plurality of time periods and includes detailed training data belonging to an associated time period and a plurality of training labels corresponding to the detailed training data, and each of the plurality of detailed training data sets has a respective one of a plurality of training label distributions;
train a plurality of machine learning models using the plurality of detailed training data sets, wherein each of the plurality of machine learning models is associated with a respective one of the plurality of time periods and is trained by using a detailed training data set belonging to an associated time period;
acquire time series data and a plurality of labels corresponding to the time series data;
determine a plurality of differences, wherein each of the plurality of differences is associated with a respective one of the plurality of time periods and is between the time series data and a detailed training data set belonging to an associated time period;
select at least one machine learning model from among the plurality of machine learning models based on the plurality of differences; and
output an inference value at an inference time point based on the time series data by using the selected at least one machine learning model.

13. The system according to claim 12, wherein each of the training time series data set and the time series data includes data including price information according to time for a stock item on a stock exchange.

14. The system according to claim 12, wherein each of the training time series data set and the time series data includes data in tensor form including:
2-dimensional (2D) data having, on an X-axis, values obtained by dividing a time by a unit time and having, on a Y-axis, values obtained by dividing the time by a unit price, the 2D data including data according to time of a quantity of each of a plurality of ask prices of a stock item on a stock exchange as values for each of a plurality of coordinates defined according to the time on the X-axis and the price on the Y-axis; and
2D data having data according to time of a quantity of each of a plurality of bid prices of a stock item on the stock exchange as values for each of a plurality of coordinates defined according to the X-axis and the Y-axis.

15. The system according to claim 12, wherein the one or more processors are further configured to determine each of the plurality of training label distributions by oversampling at least a portion of the plurality of detailed training data sets .

16. The system according to claim 15, wherein the one or more processors are further configured to, when oversampling the at least the portion of the plurality of detailed training datasets, augment at least a portion of the plurality of detailed training data sets.

17. The system according to claim 12, wherein a distribution of the acquired plurality of labels includes a distribution for labels from a current time point to a past time point that is a predetermined period of time earlier, and
the one or more processors are further configured to:
calculate a distance between the distribution for labels from the current time point to the past time point that is the predetermined period of time earlier and each of the plurality of training label distributions; and
select, from among the plurality of training label distributions that has a training label distribution, a machine learning model with a closest calculated distance to the distribution for labels from the current time point to the past time point that is the predetermined period of time earlier.

18. The system according to claim 17, wherein the predetermined period of time is adjusted to improve accuracy for inferences from the plurality of machine learning models.

19. The system according to claim 12, wherein the one or more processors are further configured to:
as a current time point changes, repeatedly generate a plurality of labels from the changed current time point to a past time point that is a predetermined period of time earlier; and
each of the plurality of differences is between the time series data including a plurality of repeatedly generated label distributions and detailed training data set including a training label distribution belonging to an associated time period.

20. The system according to claim 12, wherein each of the training data and the time series data includes data in tensor form including a plurality of 2D data according to time for at least one stock item on each of a plurality of stock exchanges.

21. (canceled)
